(19) United States
(12) Patent Application Publication
(10) Pub. No.: US 2026/0006230 A1
(43) Pub. Date: Jan. 1, 2026

(54) VIDEO TRANSCODER

(71) Applicant: Advanced Micro Devices, Inc., Santa Clara, CA (US)

(72) Inventors: Mark Ross Thompson, Milton Keynes (GB); Jonathan Philip Bonsor-Matthews, Milton Keynes (GB)

(73) Assignee: Advanced Micro Devices, Inc., Santa Clara, CA (US)

(21) Appl. No.: 18/755,919

(22) Filed: Jun. 27, 2024

(51) Int. Cl. H04N 19/40; H04N 19/176; H04N 19/423

(52) U.S. Cl. CPC H04N 19/40; H04N 19/176; H04N 19/423

(57) ABSTRACT

A technique for performing video transcoding is provided. A decoding device receives source video data in a first coding scheme. The decoding device writes one or more blocks of decoded video data to a buffer in response to the information provided by the encoding device. The encoding device encodes video data written to the buffer; wherein the encoding results in a block of encoded video data in a second coding scheme different from the first coding scheme. The writing and encoding steps are repeated for a plurality of further iterations, wherein each further iteration is initiated in response to encoding a block of video data.

### BACKGROUND

Video transcoding is a technique for converting digital video content from one encoding format to another. The process involves the transformation of video data from its original representation into a different format, which may be necessitated by a difference between the recording format of a camera and the format used for by a remote device (e.g., a display) for playback. In some cases, a video transcoding system comprises an input module such as a camera to receive the source video content, a module to decode the original video data, a memory that stores the decoded video data, and an encoding module that reads the decoded video data from memory, re-encodes it in another format, and sends it to a remote device.

In transcoding operations, the time between an input frame being captured by the input module and the re-encoded frame being sent out (in another format) to the remote device must be minimized, as that delay is directly observable in real-time communication such as videoconferencing. Reducing this delay time improves the user experience.

Transcoding is often required for videoconferencing, which can occur for long periods on battery-powered devices. Obtaining the video of the local user and encoding it to send over the network constitutes a large part of the power use in such setups. Reducing the power consumed by the transcoding operation will correspondingly increase the time with which the device can be run without recharging the battery.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of a system for video transcoding where decoded source data is written to memory, the result is read back from memory, re-encoded and sent to a remote device, according to an example;

FIG. 3 is a flow diagram of an exemplary process for transcoding implemented using the system of FIG. 2;

FIG. 4 is a block diagram of a system for transcoding, according to a further example;

FIG. 5 is a block diagram of a system for transcoding where memory in the encoder device is divided into buffer blocks, according to an example;

FIG. 6 is a flow diagram of a method for video transcoding implemented using the system of FIG. 5, according to an example;

FIGS. 7A and 7B are diagrams depicting operation of memory within an encoding device, according to an example;

FIG. 8 illustrates an exemplary frame divided into tiles;

FIG. 9 is a block diagram of a system for transcoding, according to a further example; and

FIG. 10 is a flow diagram of a method for performing transcoding, according to an example.

### DETAILED DESCRIPTION

This disclosure describes techniques for minimizing the delay and power consumption associated with video transcoding operations. In examples of the disclosed techniques, a decoding device receives source video data in a first coding scheme. An encoding device sends a request for a block of decoded data to the decoding device, and the decoding device writes the block of decoded video data to a buffer in response to the information provided from the encoding device. Alternatively, the decoding device determines, based on buffer usage information shared by the encoding device, to send one or more blocks of decoded data to the encoding device, and the decoding device writes the block of decoded video data to a buffer in response to the buffer usage information shared by the encoding device. The encoding device encodes video data written to the buffer; wherein the encoding results in a block of encoded video data in a second coding scheme different from the first coding scheme. The writing and encoding steps are repeated for a plurality of further iterations, wherein each further iteration is initiated in response to information indicating encoding of one or more blocks of video data in the second coding scheme.

In some embodiments, the encoding device sends a request for a block of decoded video directly to the decoding device. In other embodiments, the encoding device makes available information about what buffers are in use such that the decoding device reads that information and uses it to make a decision internally about when to decode and where to write the result.

In some embodiments, the buffer is divided into N buffer blocks, and the request for the block of decoded video data in a first iteration comprises a request for the decoding device to write N blocks of decoded video data to the buffer. In some embodiments where the buffer is divided into N buffer blocks, the request for the block of decoded video data in each of the further iterations includes requesting the decoding device to overwrite the decoded video data in the buffer used for encoding the previous block of video data with a next block of decoded video data.

In some embodiments, the decoding device is implemented in a first accelerated processing device, and the encoding device is implemented in a second accelerated processing device. In one of such embodiment, the first and second accelerated processing devices are on a same auxiliary processor. In some embodiments, the buffer is internal to the encoding device, while in other embodiments the buffer is external to the encoding device.

In some embodiments, the decoding device is inactive and maintains an internal state during a period between writing the block of decoded video data to the buffer and receiving a next request for a block of decoded video from the encoding device. In some examples, the decoding device receives the source video data from a USB device operating in accordance with a USB Video Class (UVC) standard.

In some examples, the first coding scheme comprises an MJPEG format and the second coding scheme comprises H.264. In some examples, a block size of the block of decoded video data written to the buffer is different from a block size of the block of encoded video data according to the second coding scheme. In one such case, the first coding scheme comprises an MJPEG format and the second coding scheme comprises an AV1 format.

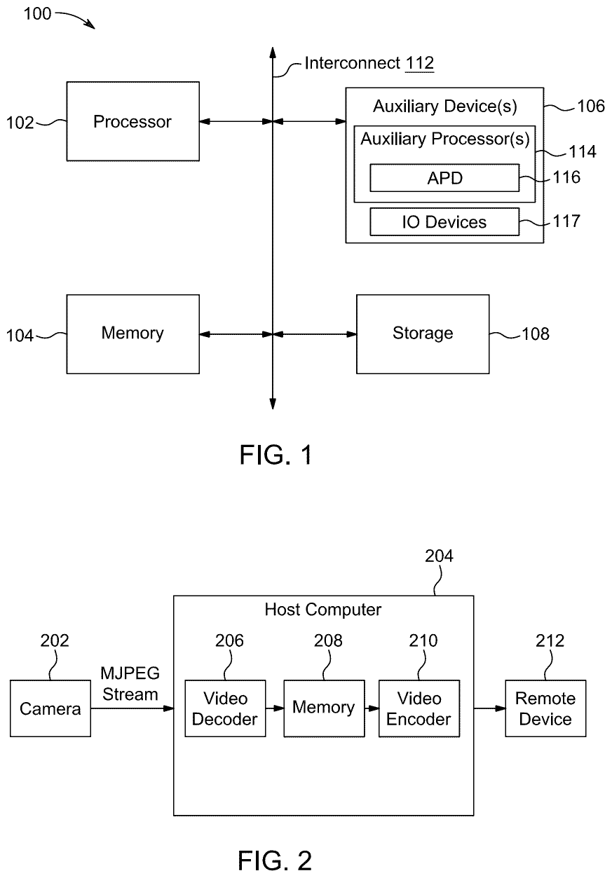

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die or package, or one or more processor cores, wherein each processor core can be a CPU, a GPU, or a neural processor. In various alternatives, at least part of the memory 104 is located on the same die or package as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. In some examples, the encoding and decoding devices described herein are each implemented on a different APD 116. APD 116 is configured to accept commands from processor 102, to process those commands, and, in some implementations, to provide pixel output to a display device for display. In some examples, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

FIG. 2 is a block diagram of a system for video transcoding in accordance with an example. An input device such as camera 202 provides source video data in the form of, e.g., an MJPEG stream to video decoder 206. In some examples, camera 202 corresponds to a built-in or external USB webcam, a professional-grade video camera or a smartphone camera. In some examples, camera 202 provides the source video data in accordance with a USB Video Class (UVC) standard. Video decoder 206 is responsible for decoding the source video data such that it can be processed into a different coding scheme that can be displayed or further processed. In some examples, video decoder 206 is implemented on a GPU or a dedicated video decoding chip. In other examples, video decoder 206 is implemented in software. Video decoder 206 is implemented to decode one or more video formats including, e.g., MPEG-2, MJPEG, H.264, H.265, VP9, AV1, Xvid, Theora, AVC-Intra, SMPTE VC-3 or SMPTE RDD 36.

In the system of FIG. 2, video decoder 206, along with memory 208 and video encoder 210, reside in a host computer 204. Memory 208 corresponds to any memory suitable for use with host computer 204 including, e.g., RAM, GPU memory, cache memory or flash memory. By way of example, video encoder 210 is implemented on a GPU, a dedicated video encoding chip or using video encoding software. In the system of FIG. 2, camera 202 provides source video data in a first coding scheme to decoder 206. The decoder 206 decodes the source video data and writes the resulting decoded video data to memory 208. Video encoder 210 reads back the decoded video data from memory 208, re-encodes the video data in a second (different) coding scheme, and sends it to a remote device 212, e.g., a far end of a video conference, a file and/or a display.

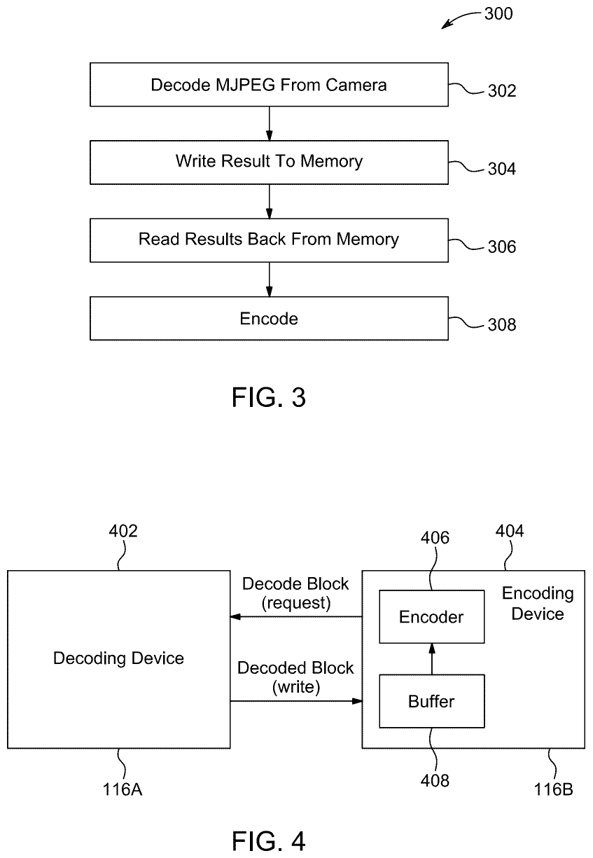

FIG. 3 is a flow diagram of an exemplary method 300 for video transcoding implemented on the system shown in FIG. 2. In method 300, each step of the transcoding operation is mediated by the operating system of host computer 204. In step 302, decoding device 206 receives source video data (e.g., in the MJPEG format) from camera 202. In one example, step 302 occurs during a video conference. After receiving the source video data at host computer 204, video decoder 206 decodes the source video data.

In step 304, video decoder 206 writes the resulting decoded video data to memory 208. A memory write operation typically involves identifying an address in the memory where the data will be stored, selecting the appropriate row of memory or memory bank, transferring the data to the selected memory location using appropriate write signals.

In step 306, the decoded video data is read back from memory 208. A memory read operation typically involves identifying an address in the memory from which the data will be retrieved, selecting the appropriate row of memory or memory bank, transferring the data from the selected memory location.

In step 308, video data read back from memory 208 is re-encoded by video encoder 210 in a different coding scheme and sent to remote device 212.

The transcoding operation described in connection with FIGS. 2 and 3 includes a round-trip to memory 308 where output from the decoder 206 is written out to memory 206 and then read back again later to be input to video encoder 210. In the context of software and computing, such a “round-trip” generally refers to a process where data is transferred from a storage medium (such as RAM or a persistent storage device) to a processing unit (e.g., CPU), undergoes some operations, and is then written back to the storage medium. The entire cycle, involving the retrieval, processing, and writing of data, is considered a round-trip to and from memory and represents, e.g., a complete iteration of data movement between a storage medium and one or more processing units. A round trip to and from memory is considered expensive in that it often contributes to increased latency, resource consumption (e.g., consumption of bus bandwidth) and energy consumption. A round-trip consumes energy and, in mobile devices or systems with limited power budgets, minimizing the number of round trips is advantageous in that it conserves energy.

The transcoding embodiments discussed below combine steps of this process. This approach reduces latency by having two steps run simultaneously with direct synchronization between them rather than having each step mediated by the host operating system. When the host operating system mediates the process, it essentially serves as the manager or facilitator of the process. In some examples of the transcoding embodiments, the host processor does not function as a mediator of the process. The approach described below also reduces power consumption, as the total memory bandwidth used is significantly lower having eliminated both a read and write operation.

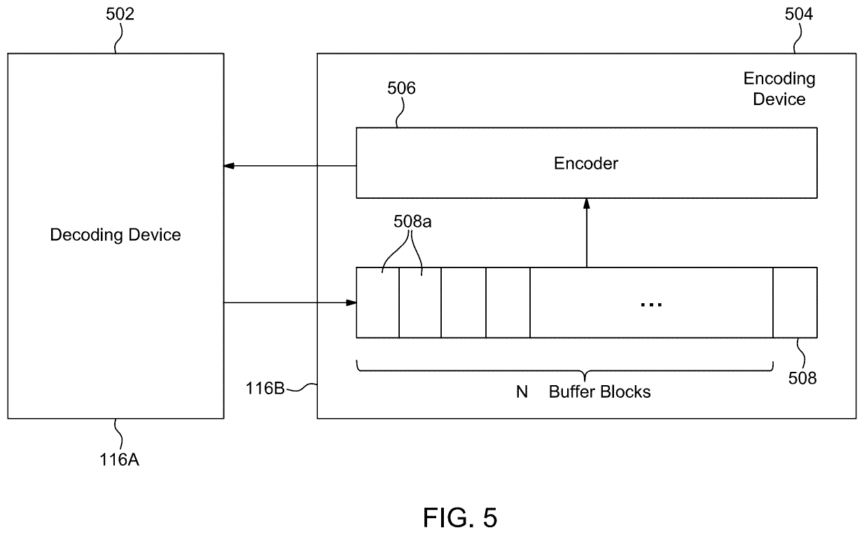

FIG. 4 is a block diagram of a system for video transcoding, according to a further example. In this example, a video decoding device 402 is implemented on a first APD 116A, and a video encoding device 404 is implemented on a second APD 116B. Decoding device 402 receives source video data in a first coding scheme from a source (not shown). Encoding device 404 re-encodes video data according to a different encoding scheme and sends it to a remote device (also not shown). In the example, following initialization (discussed in more detail below), encoding device 404 sends a request for a block of decoded video directly to the decoding device 402. Decoding device 402 writes the block of decoded video data to buffer 408 in encoding device 402 in response to the request from the encoding device. Encoder 406 encodes the video data written to buffer 408 (resulting in a block of encoded video data in a second coding scheme different from the first coding scheme) and sends a request to decoding device 402 for a further block of decoded video data.

In some examples, buffer 408 contains multiple blocks of decoded video data that have not yet been re-encoded by encoder 406, and the buffer is looped in a manner that allows encoder 406 to re-encode a next block of data from the buffer in parallel with decoding device 402 overwriting portion(s) of the buffer storing data that has already been re-encoded by encoder 406 with additional block(s) of decoded video. In some examples, decoding device 402 is inactive and maintains an internal state during a period between writing the block of decoded video data to the buffer and receiving a next request for a block of decoded video from the encoding device.

In contrast to the examples of FIGS. 2 and 3, the example of FIG. 4 (as well as the other examples set forth below) remove a round-trip to memory where the output from the decoding device is written out and then read back again later to be the input to the encoding device. This reduces latency as the processes now run simultaneously with direct synchronization between the encoding and decoding devices, rather than each step being mediated by the host operating system. This approach also reduces resource use and power consumption, as the total memory bandwidth used is now lower having eliminated both a read and write operation, and power associated with the round-trip to memory is conserved. In some examples, the transcoding process described herein does not make use of system memory.

While in the example of FIG. 4, the transcoding operation is shown as including a decoding operation followed by a re-encoding operation, it will be understood that further intermediate processing operations (not shown) are within the scope of this disclosure. By way of example, such intermediate processing operations include scaling, frame rate adjustment, downsampling, and color space conversion (e.g., RGB to YUV).

FIG. 5 is a block diagram of a system for transcoding where memory in encoding device 504 is divided into buffer blocks in a manner that facilitates the buffer being looped. In this example, buffer 508 (within encoding device 504) has N buffer blocks 508a. A buffer block, in the context of computing and data processing, typically refers to a contiguous section or unit of memory that is used as a temporary storage area for data. The term “block” emphasizes that the buffer is divided into discrete chunks or segments. As explained below, in some examples dividing the buffer into buffer blocks facilitates buffer looping that hides decoding and transmission latency.

In the example of FIG. 5, decoding device 502 is implemented on a first APD 116A, and encoding device 504 is implemented on a second APD 116B. Encoding device 504 re-encodes video data according to a different coding scheme and sends it to a remote device (also not shown). Before encoding device 506 begins the re-encoding operation, encoding device 504 sends a request to decoding device 502 requesting the decoding device to decode the first N blocks of source video data. In response, decoding device 502 writes the first N blocks of decoded source video data to the first N buffer blocks 508a in buffer 508. The N blocks are processed in series, and the encoder can start re-encoding before all have arrived. Encoding device 506 re-encodes the video data written to one or more of the buffer blocks 508a (resulting in a block of encoded video data in a second coding scheme different from the first scheme) and then sends a request to decoding device 502 for one or more further blocks of decoded video data. In response, decoding device 502 writes the next blocks of decoded video data over the data in the first buffer blocks 508a that have already been re-encoded. Division of buffer 508 into buffer blocks 508a facilitates buffer looping. In one example, buffer blocks 508a are looped by encoding a block from the buffer with the encoding device 504 after which the encoding device 504 requests the decoding device 502 to write the next decoded block into the buffer block that has just been finished. This looping process reduces latency by allowing encoding device 504 to re-encode the data in the next buffer block while decoding device 502 overwrites the buffer block that just finished with new encoded video data.

Again, in contrast to the examples of FIGS. 2 and 3, the example of FIG. 5 removes a round-trip to memory where the output from the decoding device is written out and then read back again later to be the input to the encoding device. This reduces latency as the processes now run simultaneously with direct synchronization between the encoding and decoding devices, rather than each step being mediated by the host operating system. This approach also reduces resource use and power consumption, as the total memory bandwidth used is now lower having eliminated both a read and write operation, and power associated with the round-trip to memory is conserved.

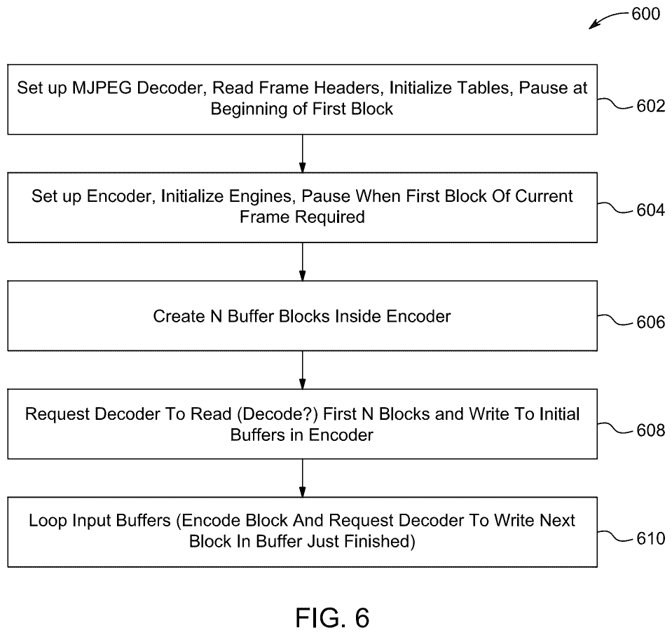

FIG. 6 is a flow diagram of a method 600 for video transcoding implemented using the system of FIG. 5, according to an example where the source coding scheme comprises a MJPEG format, and the source coding scheme is transcoded into an H.264 coding scheme. It should be understood that these are mere examples of video coding schemes and the transcoding can be performed for any video coding schemes. In one or more examples, the first and second coding schemes differ by at one of the following parameters: encoding format, bit rate, framerate, resolution, and/or colour representation.

In step 602, the MJPEG decoder is set-up (e.g., by reading frame headers and initializing tables) and then paused at the beginning of the first block of source video data. In some examples, the frame header for JPEG contains standalone parameters required by the decoding process, such as the size of the image and how it is subsampled, along with some tables. The quantisation tables are contained directly in the frame header, and are needed to reconstruct the coefficients used as input to the inverse transform. Entropy coding tables are given in a coded form, from which the decoder must construct the actual table during this initialisation process. The entropy coding tables are then used to determine the meaning of sequences of bits in the entropy-coding parts of the bitstream.

In one example, the MJPEG decoder is implemented on an APD 116. Alternatively, or in addition to implementation of the MJPEG decoder on an APD, the MJPEG decoder is implemented on a GPU or a dedicated video decoding chip. In other examples, the MJPEG decoder is implemented in software.

In step 604, the H.264 encoder is set-up by initializing all engines, and then paused when the first block of the current frame is required. In some examples, the encoder setup involves configuration of programmable parameters of the encoder (such as, e.g., those related to quality and rate control, which will come from the user) and also providing the information from previous frames which will be needed to encode the present frame (such as, e.g., reference frames, and other temporal information like motion vectors required by the codec operation). A typical hardware encoder is composed of various engines to perform different parts of the encoding process (e.g. motion estimation, mode decision, transforms). These engines will typically have different parameters which need to be programmed before the encoder begins.

In one example, the H.264 encoder is implemented on an APD 116. Alternatively, or in addition to implementation of the MJPEG decoder on an APD, the H.264 encoder is implemented on a GPU or a dedicated video decoding chip. In other examples, the H.264 encoder is implemented in software.

In step 606, the H.264 encoding device divides its buffer into N buffer blocks. As explained above, division of the buffer into buffer blocks facilitates buffer looping. In some examples, the size and arrangement of each the buffer blocks is selected in accordance with the particular source video coding scheme and re-encoded video coding scheme associated with the transcoding operation. In some examples, the size and arrangement of the buffer blocks is driven by differences in the relative block sizes or block ordering associated with the source video coding scheme and re-encoded video coding scheme.

In step 608, the encoding device sends a request to the MJPEG decoder to decode the first N blocks. In response, the MJPEG decoder writes the first N blocks of decoded video data to the initial N buffer blocks in the buffer.

In step 610, the encoding and decoding devices loop the buffer blocks as discussed above by encoding a block from the buffer with the encoding device after which the encoding device requests the decoding device to write the next decoded block into the buffer block that has just been finished. This looping process reduces latency by allowing encoding device to re-encode the data in the next buffer block while the decoding device overwrites the buffer block that just finished with new encoded video data.

In some examples, steps 608 and 610 will overlap such that the encoder will run if it has any blocks available, and similarly the decoder is going to be requested to run if there is any space for its output. Running the encoder and decoder in parallel with this buffering in between can also hide latency if some operation takes longer than expected (e.g. if the decoder is blocked waiting for input, the encoder can still proceed to encode the rest of the buffered blocks before it has to wait as well).

While in the example of FIG. 6, the transcoding operation is shown as including a decoding operation followed by a re-encoding operation, it will be understood that further intermediate processing operations (not shown) are within the scope of this disclosure. By way of example, such intermediate processing operations include scaling, frame rate adjustment, downsampling, and color space conversion (e.g., RGB to YUV).

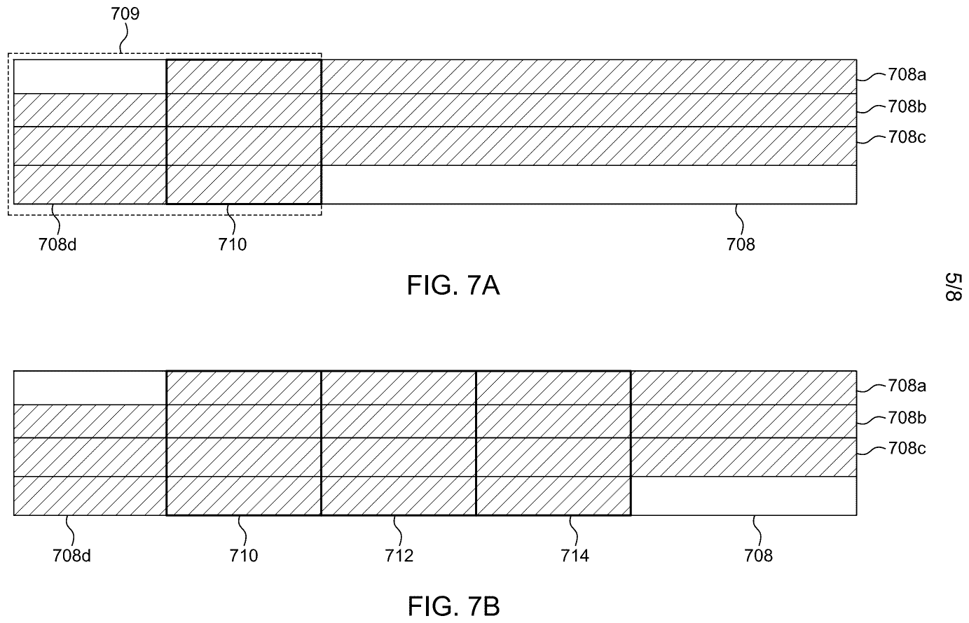

In the example of FIG. 6 (i.e., source coding scheme comprises MJPEG format and re-encoded using H.264), the JPEG block size matches (or roughly matches) the H.264 block size, which simplifies the sizing, arrangement and looping of the buffer blocks. However, in other examples of the techniques described herein, the block sizes of the source coding scheme and the re-encoded data do not match. In some examples, the expected JPEG block sizes are 16×16, 16×8 or 8×8 (and it is known from the JPEG frame headers which of these will be received). If it is 16×16 (most likely) then sizes will match; if not, additional buffering will be used as shown, e.g., in FIGS. 7A/7B.

One such example is a JPEG to AV1 transcode. AV1 uses a large block structure referred to as a “superblock,” which is typically a square block with a fixed size of either 64×64 or 128×128 pixels that differs in size from the blocked used by JPEG. In some examples, at the choice of the encoder, buffering is kept at the lower level by the encoder choosing to always use 64×64 blocks. In other examples, the encoder can select the larger size blocks.

In order to accommodate this difference, the buffering for the transcoding operation includes a complete row of superblocks of the image. The internal memory required for such buffering is proportional to the width of the image, so in some examples it is advantageous to set an upper bound on the supported width (e.g. 1920 pixels to support 1080p). Alternatively, tiles could be used to allow encodes larger than the line buffer, in which case multiple passes across the input JPEG data are required. Other alternatives are described below.

FIGS. 7A and 7B are diagrams depicting operation of buffer 708 within an encoding device according to an example where the transcode is from JPEG to AV1. The buffer includes lines 708a-d, each of which comprises a number of buffer blocks. The cross-hatching in FIGS. 7A and 7B corresponds to decoded video data (from the decoding device) that has been written to buffer 708.

As shown, lines 708a and 708d are partially filled with decoded video data, while all of the buffer blocks in lines 708b and 708c are filled with decoded video data. The decoded data in block 710 (which spans all four lines) represents the decoded data to be used by the encoder to encode the next AV1 superblock.

In one embodiment, once the superblock corresponding to 710 is encoded, the portion of the buffer corresponding to region 709 is re-written with further decoded data in response to the next request from the encoder for further data.

Blocks 712 and 714 in FIG. 7B depict the decoded data to be used by the encoder to encode the two subsequent AV1 superblocks. The buffer is looped such that, after each of the superblocks corresponding to 712 and 714 is encoded, the encoder issues a further request to the decoder to overwrite further decoded video data in the areas corresponding to 712 and 714. The method discussed in connection with FIGS. 7A and 7B is also applicable to transcodes involving other source codecs, such as SMPTE VC-3 and SMPTE RDD 36.

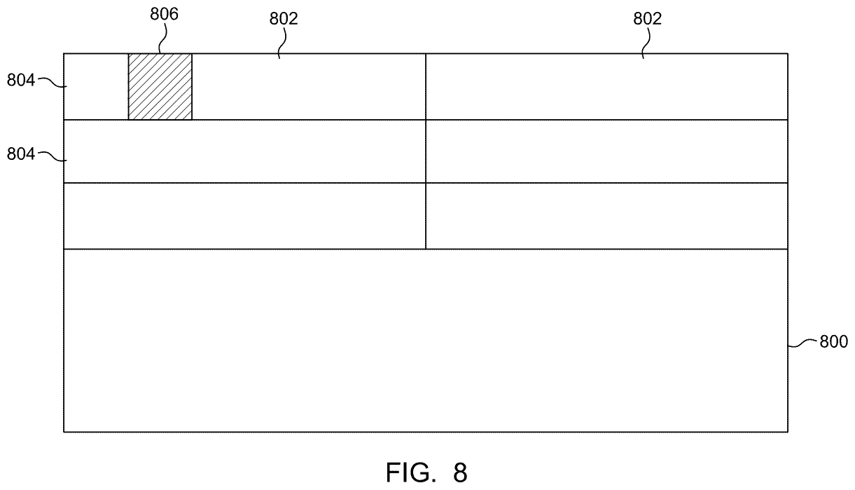

For SMPTE VC-3 and SMPTE RDD 36, the large line buffer when the destination codec is AV1 would no longer be needed, and the tile encode is more efficient because SMPTE VC-3 and RDD 36 have some amount of random access support so that the decode can start at an arbitrary point in the frame. For example, referring to FIG. 8, an exemplary frame 800 is divided in tiles 802. Each tile 802 is a rectangular region of the frame encoded as one piece. In the example shown, each line 804 is contained within two tiles 802. The first tile 802 includes an encoder block 806. In an example such as VC-3, the decoder does not decode complete lines 804 at a time and instead fills in the next part of a set of lines as the encoder asks for the next group of blocks to encode. For example, for each block line 804 the decoder writes the part of the line which is within the tile directly to the encoder while discarding the rest of the row. In some examples of this implementation, the offsets within the line are stored to allow the decoder to decode blocks starting from a point within a row. Alternatively, instead of discarding the rest of the row, the decoder stores the portion of the line outside of the tile for use at a later time when needed by the encoder.

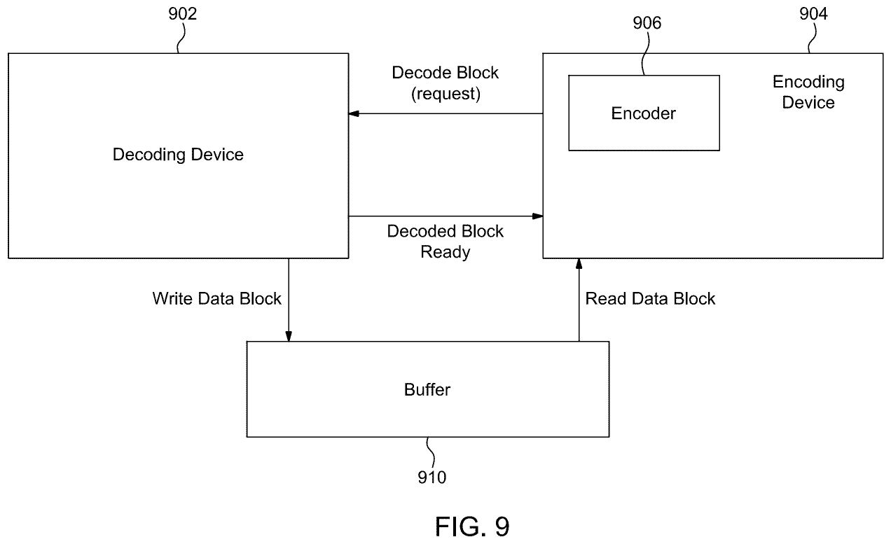

FIG. 9 is a block diagram of a system for transcoding, according to a further example. In contrast to the embodiments of FIGS. 4 and 5, in the alternative of FIG. 9, the buffer (i.e., buffer 910) is not internal to encoding device 904. For example, buffer 910 is found in a cache on the same package as the decoding or encoding devices or in an external memory. However, control signals still pass directly between encoding device 904 and decoding device 902, achieving some of the latency gains associated with earlier embodiments. In some examples, decoding device 902 and encoding device 904 are implemented on separate APDs.

Like the embodiments described above, decoding device 902 receives source video data in a first coding scheme from a source (not shown), and encoder 906 in encoding device 904 re-encodes video data in a different coding scheme and sends it to a remote device (also not shown). Following initialization, encoding device 904 sends a request for a block of decoded video directly to the decoding device 902. Decoding device 902 writes the block of decoded video data to buffer 910 in response to the request from the encoding device. Encoder 906 encodes the video data written to buffer 910 (in a second different encoding scheme) and sends another request to decoding device 902 for a further block of decoded video data. In some examples, buffer 910 is divided into buffer blocks in a manner that facilitates the buffer being looped, as described above. In this example, encoder 906 starts encoding the next block immediately when it is available, rather than the decode process signaling to the host operating system which then triggers the encode process.

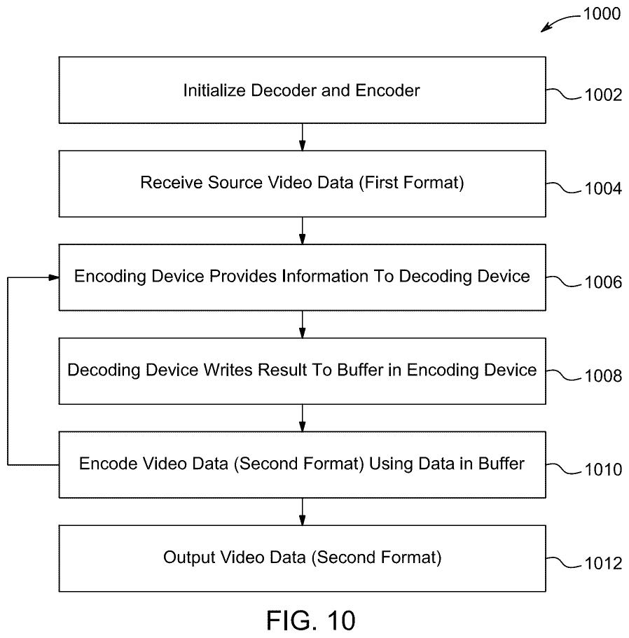

FIG. 10 is a flow diagram of a method 1000 for performing transcoding, according to an example. Among other differences, in contrast to method 600 (FIG. 6), method 1000 does not specify division of the buffer into buffer blocks.

In step 1002, the encoding device and the decoding device are each initialized. In some examples, the decoder is initialized by reading frame headers and initializing tables, and then paused at the beginning of the first block of source video data. In some examples, the encoder is initialized by initializing engines internal to the encoder, and pausing the encoder when the first block of decoded video data is required.

In step 1004, the decoding device receives source video data in a first coding scheme. In some examples, the source video data is provided by a webcam, a professional-grade video camera or a smartphone camera. In some examples, the webcam or camera provides the source video data in accordance with a UVC standard.

In step 1006, the encoding device provides information to the decoding device. In some embodiments, the encoding device provides the information by sending a request for block(s) of decoded video directly to the decoding device. In other embodiments, the encoding device provides the information by making available information about what buffers are in use such that the decoding device reads that information and uses it to make a decision internally about when to decode and where to write the result.

The decoding device decodes the source video data such that it can be processed into a different coding scheme that can be displayed or further processed. In some examples, the decoding device is implemented to decode one or more video formats including, e.g., MPEG-2, MJPEG, H.264, H.265, VP9, AV1, Xvid, Theora, AVC-Intra, SMPTE VC-3 or SMPTE RDD 36.

In step 1008, the decoding device writes the block of decoded video data to a buffer in response to the request from the encoding device. In some examples the buffer is internal to the encoding device, while in other examples the buffer is external to the encoding device. The encoding device is implemented to encode one or more video formats including, e.g., MPEG-2, MJPEG, H.264, H.265, VP9, AV1, Xvid, Theora, AVC-Intra, SMPTE VC-3 or SMPTE RDD 36.

In step 1010, the encoding device encodes video data written to the buffer in a second coding scheme different from the first coding scheme, at which point the process loops back to step 1006. Iteration of the loop continues until the transcoding process is completed. In step 1012, video data encoded in the second coding scheme is output by the encoding device. It will be understood that the outputting (step 1012) of each block of encoded data occurs as each encoded video block is generated.

While in the example of FIG. 10, the transcoding operation is shown as including a decoding operation followed by a re-encoding operation, it will be understood that further intermediate processing operations (not shown) are within the scope of this disclosure. By way of example, such intermediate processing operations include scaling, frame rate adjustment, downsampling, and color space conversion (e.g., RGB to YUV).

In some embodiments, the buffer is divided into N buffer blocks, and the request for the block of decoded video data in the first iteration comprises a request for the decoding device to write N blocks of decoded video data to the buffer. In some embodiments where the buffer is divided into N buffer blocks, the request for the block of decoded video data in each of the further iterations includes requesting the decoding device to write a next block of decoded video data into a buffer block storing decoded video data used for encoding the previous block of video data in the second format.

In some embodiments, the decoding device is implemented in a first accelerated processing device, and the encoding device is implemented in a second accelerated processing device. In an example of such embodiments, the first and second accelerated processing devices are on a same auxiliary processor.

In some embodiments, the decoding device is inactive and maintains an internal state during a period between writing the block of decoded video data to the buffer and receiving a next request for a block of decoded video from the encoding device.

In some examples, the decoding device receives the source video data from a USB device operating in accordance with a USB Video Class (UVC) standard. In some examples, the first coding scheme is an MJPEG format and the second coding scheme is H.264. In some examples, a block size of the block of decoded video data written to the buffer is different from a block size of the block of encoded video data in the second coding scheme. In one such case, the first coding scheme comprises an MJPEG format and the second coding scheme comprises an AV1 format. The method is also applicable to transcodes involving other source codecs, such as SMPTE VC-3 and SMPTE RDD 36. For SMPTE VC-3 and SMPTE RDD 36, the large line buffer when the destination codec is AV1 would no longer be needed, and the tile encode would be more efficient.

Each of the described herein functional blocks (e.g., encoding device, encoder, decoding device, decoder, buffer, memory, or any other block in the figures) can be implemented in software or firmware executing on a programmable processor, as fixed-function circuitry, as configurable circuitry, as any type of processor including a field programmable gate array or programmable logic device, or as any other form of circuitry.

It should be understood that many variations are possible based on the disclosure herein. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing a video transcoding operation, the method comprising:
receiving, by a decoding device, source video data in a first coding scheme;
writing, by the decoding device, at least one block of decoded video data to a buffer; wherein the writing is performed in response to at least one of: a request for decoded video data made by an encoding device to the decoding device or buffer usage information shared by the encoding device with the decoding device;
encoding, by the encoding device, video data written to the buffer; wherein the encoding results in a block of encoded video data encoded in a second coding scheme different from the first coding scheme; and
repeating the writing and encoding for a plurality of further iterations, wherein each further iteration is initiated in response to encoding one or more blocks of video data in the second coding scheme.

2. The method of claim 1, further comprising:
providing, from the encoding device to the decoding device, a request for the block of decoded video; wherein the writing is performed in response to the request.

3. The method of claim 2, wherein the buffer is in the encoding device and the buffer is divided into N buffer blocks; and
wherein the request for the block of decoded video data in a first iteration comprises a request for the decoding device to write N blocks of decoded video data to the buffer.

4. The method of claim 2, wherein the buffer is divided into N buffer blocks; and wherein the request for the block of decoded video data in each of the further iterations further comprises requesting the decoding device to write a next block of decoded video data into a buffer block storing decoded video data used for encoding a previous block of video data.

5. The method of claim 1, wherein the decoding device is implemented in a first accelerated processing device, and the encoding device is implemented in a second accelerated processing device.

6. The method of claim 5, wherein the first and second accelerated processing devices are on a same auxiliary processor.

7. The method of claim 1, wherein the decoding device receives the source video data from a USB device operating in accordance with a USB Video Class (UVC) standard.

8. The method of claim 1, wherein a block size of the block of decoded video data written to the buffer is different from a block size of the block of encoded video data in the second coding scheme.

9. The method of claim 2, wherein the decoding device is inactive and maintains an internal state during a period between writing the block of decoded video data to the buffer and receiving a next request for a block of decoded video from the encoding device.

10. A system for performing a transcoding operation, the system comprising:
a decoding device configured to perform operations including:
receiving source video data in a first coding scheme;
receiving, from an encoding device, information indicating a block of decoded video; and
writing at least one block of decoded video data to a buffer; wherein the decoding device performs the writing in response to at least one of: a request for decoded video data made by the encoding device to the decoding device or buffer usage information shared by the encoding device with the decoding device; and
the encoding device configured to perform operations including:
encoding video data written to the buffer; wherein the encoding results in a block of encoded video data encoded in a second coding scheme different from the first coding scheme.

11. The system of claim 10, wherein the encoding device provides a request for the block of decoded video to the decoding device; and
the decoding device writes the block of decoded video data to the buffer in response to the request.

12. The system of claim 11, wherein the buffer is in the encoding device, the buffer is divided into N buffer blocks; and wherein a first request for the block of decoded video data comprises a request for the decoding device to write N blocks of decoded video data to the buffer.

13. The system of claim 12, wherein the buffer is divided into N buffer blocks; and wherein each of further requests for blocks of decoded video data further comprises a request to the decoding device to write a next block of decoded video data into a buffer block storing decoded video data used for encoding a previous block of video data.

14. The system of claim 10, wherein the decoding device comprises a first accelerated processing device, and the encoding device comprises a second accelerated processing device.

15. The system of claim 14, wherein the first and second accelerated processing devices are on a same auxiliary processor.

16. The system of claim 10, wherein the decoding device receives the source video data from a USB device operating in accordance with a USB Video Class (UVC) standard.

17. The system of claim 10, wherein the second coding scheme comprises an AV1 format and the writing comprises writing a complete row of superblocks to the buffer.

18. The system of claim 11, wherein the decoding device is inactive and maintains an internal state during a period between writing the block of decoded video data to the buffer and receiving a next request for a block of decoded video from the encoding device.

19. A non-transitory computer-readable medium storing instructions that, when executed by a processor, cause the processor to perform operations comprising:
receiving, by a decoding device, source video data in a first coding scheme;
writing, by the decoding device, one or more blocks of decoded video data to a buffer; wherein the writing is performed in response to at least one of: a request for decoded video data made by an encoding device to the decoding device or buffer usage information shared by the encoding device with the decoding device;
encoding, by the encoding device, video data written to the buffer; wherein the encoding results in a block of encoded video data in a second coding scheme different from the first coding scheme; and
repeating the writing and encoding steps for a plurality of further iterations, wherein each further iteration is initiated in response to encoding at least one block of video data in the second coding scheme.

20. The non-transitory computer-readable medium of claim 19, wherein the encoding device provides a request for the block of decoded video to the decoding device; and the decoding device writes the block of decoded video data to the buffer in response to the request; and
wherein the buffer is in the encoding device, the buffer is divided into N buffer blocks; and wherein the request for the block of decoded video data in each of the further iterations further comprises requesting the decoder to write a next block of decoded video data into a buffer block storing decoded video data used for encoding a previous block of video data.
